(19) United States
(12) Patent Application Publication
(10) Pub. No.: US 2005/0138207 A1
(43) Pub. Date: Jun. 23, 2005

(54) Method and apparatus for transporting language-independent messages through generic management frameworks

(75) Inventors: Ping Chen, Austin, TX (US); John Paul Dodson, Pflugerville, TX (US); Minh Nguyen, Austin, TX (US); Quan Wang, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/738,228

(22) Filed: Dec. 17, 2003

(51) Int. Cl. G06F 15/16

(52) U.S. Cl. 709/246

(57) ABSTRACT

A method, apparatus and computer instructions are disclosed for seamlessly transporting a language-independent message (e.g., embedded NLS emblems) encoded from a source code at a layer below a management framework, through the management framework, and on to a client layer for consumption by a user. Consequently, for example, the process of displaying an error condition message to a client can be decoupled completely from the point where the error occurred, but the details and context of the error can still be preserved. As such, a generic solution is disclosed that is independent of the NLS language and locale and particular management framework involved. Advantageously, for example, a system programmer can write a significant amount of a system's messaging code independently of the management framework involved.

### BACKGROUND OF THE INVENTION

1. Technical Field:

The present invention relates generally to an improved data processing system, and in particular, but not exclusively, to a method, apparatus and computer instructions for seamlessly transporting language-independent messages, such as, for example, messages including embedded National Language Support (NLS) emblems, through generic management frameworks.

2. Description of Related Art:

Systems management is the field of Information Technology (IT) related to the configuration and management of computer resources. Currently, most systems management functions make use of an intermediate management framework to perform management tasks, such as the Common Information Model (CIM), Simple Network Management Protoclo (SNMP), Simple Management Protoclo (SMP), and other similar management frameworks. For example, in an object-oriented system (e.g., using Java or C++ programming languages), a typical intermediate management framework used can be a set of classes that embodies an abstract design for the solutions to a number of related management problems. Typically, these intermediate management frameworks allow network managers to customize or extend their networks' management frameworks to suit the particular business needs of the customers involved.

However, a drawback of existing intermediate management frameworks is that the programming code used for customizing network frameworks is typically limited to the support provided for communications using messages. For example, when an error condition occurs with respect to the code used for customizing a network's framework, an appropriate error condition message can be created immediately. The “customized” code can create the error condition message. The error condition message is thus immediately available for reporting the error condition to the client. However, the process of actually reporting the error condition to the client is delayed to a significant extent, because the error condition information is first conveyed to the management framework, which then communicates an “exception” containing the error message to the client.

Therefore, it would be advantageous to have an improved method, apparatus and computer instructions for seamlessly conveying language-independent information (e.g., NLS emblems) through any generic management framework and directly on to a client layer for timely consumption and use by the client.

### SUMMARY OF THE INVENTION

The present invention provides a method, apparatus and computer instructions for seamlessly transporting language-independent message information, such as, for example, embedded NLS emblems, from a message source, through a management framework, and on to a client layer. In accordance with a preferred embodiment of the present invention, a set of NLS emblems can be embedded in a message in a management framework, transported through the management framework, and then reconstituted in the NLS locale of choice at the client layer. Consequently, for example, the process of displaying an error condition message to a client can be decoupled completely from the point where the error occurred, but the details and context of the error can still be preserved. As such, the present invention provides a generic solution that is independent of the NLS locale used and particular management framework involved. Advantageously, for this example, the present invention allows a system programmer to write a significant amount of a system's messaging code independently of the management framework involved.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing syetem in which the present invention may be implemented; and

FIGS. 4A-4C are related flowcharts for a process that seamlessly transports a message of embedded NLS emblems from a source code through a management framework, and on to a client layer, in accordance with a preferred embodiment of the present invention.

### DETAILED DESCRIPTION OF THE PREFERRED EMBODIMENT

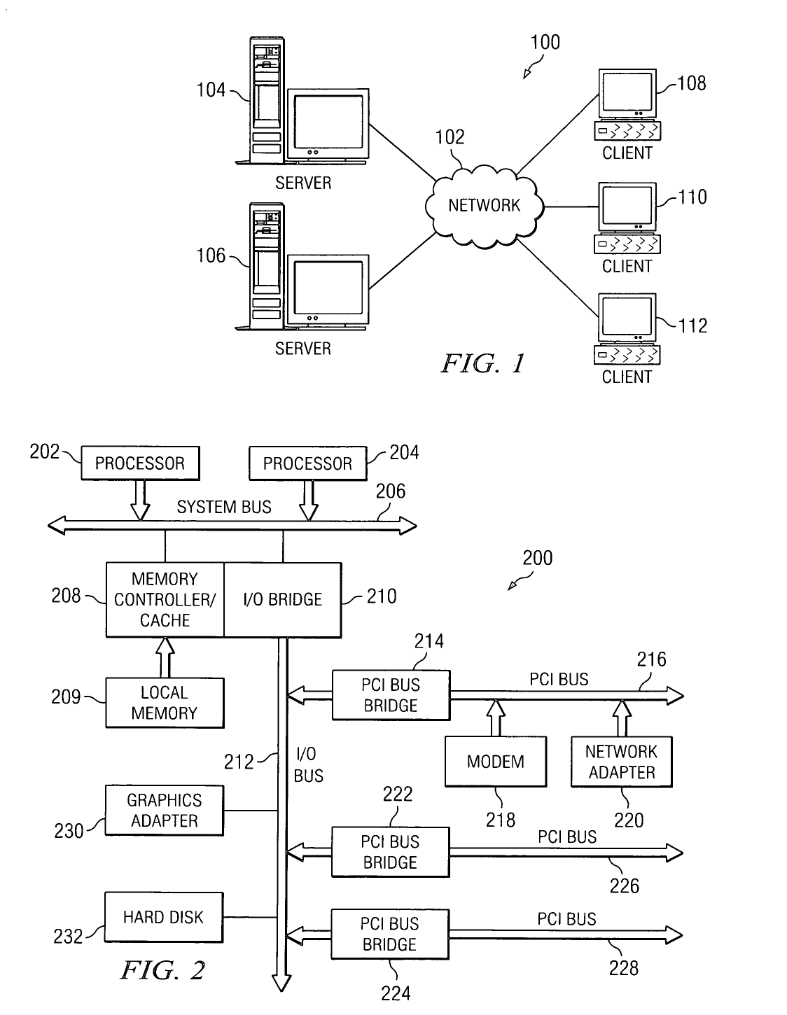

With reference now to the figures, FIG. 1 depicts a pictorial representation of a network of data processing systems in which the present invention may be implemented. Specifically, network data processing system 100 is a network of computers in which the present invention may be implemented. Network data processing system 100 includes a network 102, which is the medium used to provide communications links between various devices and computers connected together within network data processing system 100. Network 102 may include communication connections, such as wire, wireless communication links, or fiber optic cables.

In the depicted example, server 104 is connected to network 102 along with server 106. In addition, clients 108, 110, and 112 are connected to network 102. Clients 108, 110, and 112 may be, for example, personal computers or network computers. In this illustrative example, server 106 and clients 108, 110, 112 can be clients to server 104.

Server 104 (and/or server 106) can provide data, such as boot files, operating system images, and applications to clients 108, 110, 112. As such, network data processing system 100 may include additional servers, clients, and other devices not shown. In the depicted example, network data processing system 100 can be the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a Local Area Network (LAN), or a Wide Area Network (WAN). In any event, FIG. 1 is intented as an example, and not as an architectural limitation for the present invention.

For this exemplary embodiment, a method, apparatus, and computer instructions are provided for server 104 to seamlessly transport language-independent message information (e.g., embedded NLS emblems) from an extension (e.g., code) typocally at a level below a management framework, through the management framework, and on to a client layer for consumption by a user (e.g., via a user interface associated with server 106 or one or more of clients 108, 110, 112). For this example, a CIM management framework can be used by server 104 as an intermediate management framework to implement the present invention. However, the present invention is not intended to be so limited, and any appropriate intermediate management framework (SNMP, SMP, etc.) can be used.

Referring to FIG. 2, a block diagram of a data processing system that may be implemented as a server, such as server 104 or server 106 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108, 110, 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in a disturbance of its magnetic environment. One is T1 or longitudinal relaxation time, the external magnetic field; the other is T2, the spin relaxation time, a measure of the time respect to the present invention.

The data processing system depicted in FIG. 2 may be, for example, an IBM eServer pseries system, a product of International Business Machines Corporation in Armonk, N.Y. running the Advanced Interactive Executive (AIX) operating system or LINUX operating system.

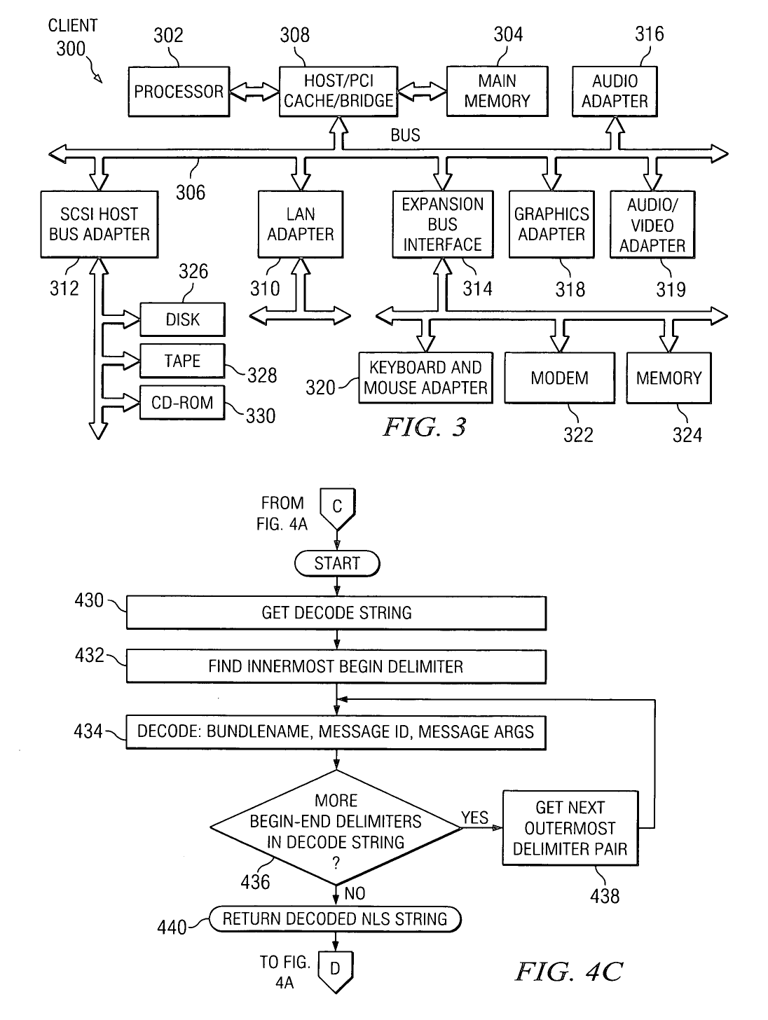

With reference now to FIG. 3, a block diagram illustrating a data processing system is depicted in accordance with a preferred embodiment of the present invention. Data processing system 300 is an example of a client computer (e.g., client 108, 110, 112 in FIG. 1). Data processing system 300 employs a PCI local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, LAN adapter 310, Small Computer System Interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Linux. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

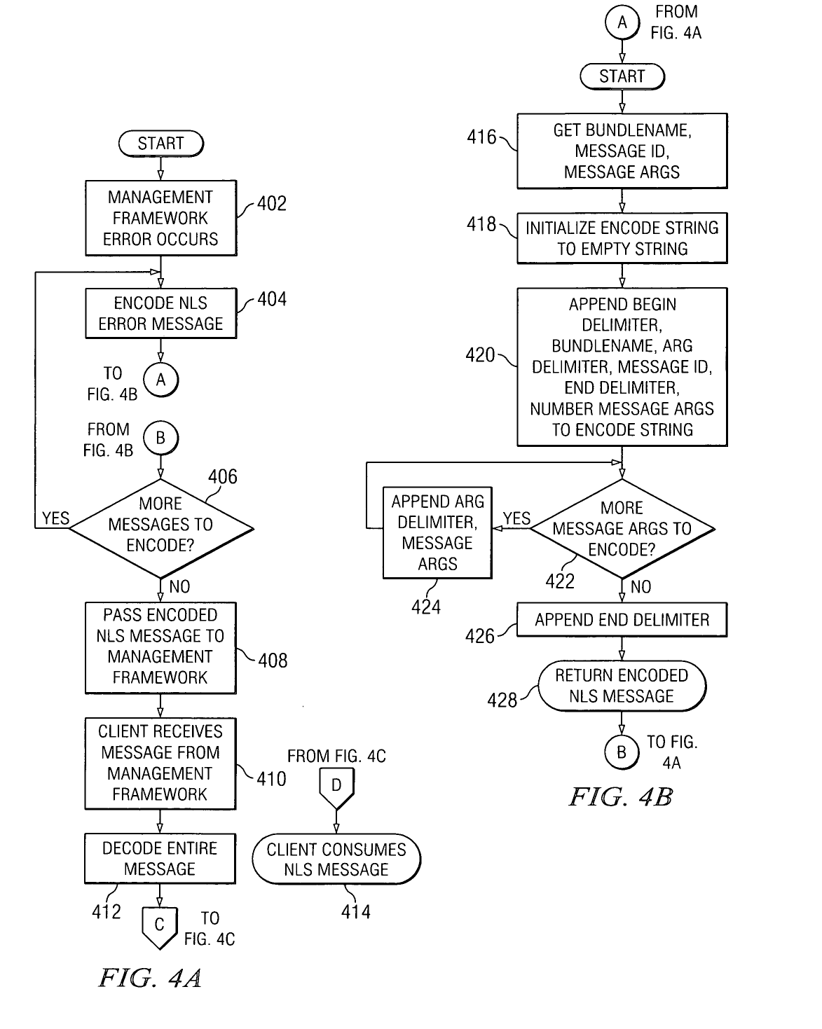

With reference now to FIGS. 4A-4C, related flowcharts for a process for seamlessly transporting one or more language-independent information messages (e.g., embedded NLS emblems) from a source code at a layer below a management framework, through the management framework, and on to a client layer are depicted in accordance with a preferred embodiment of the present invention. The process illustrated in FIGS. 4A-4C can be implemented, for example, by server 104 in a server messaging process, such as an error condition identification and reporting process.

For this exemplary embodiment, referring to FIG. 4A (e.g., entitled “Life Cycle of NLS Error Messages”), the process begins when an error condition occurs with a management process at the intermediate management framework layer (step 402). At this point, it is important to note that although the illustrative example of FIGS. 4A-4C describes a process for encoding, transporting and decoding an error message, the present invention is not intended to be so limited. Any appropriate message or similar type of information can be encoded, transported and decoded by the process shown in FIGS. 4A-4C.

For this exemplary embodiment, it may be assumed that Java extension code (e.g., running in a CIM management framework process) can be used on server 104 to provide specific management support functions for users (e.g., via a user interface running on server 104, server 106, or one of clients 108, 110, 112) in response to one or more requests by a user. For illustrative purposes only, it may be assumed that an error has occurred with respect to a particular management support function being performed on server 104. In accordance with the present invention, in response to the occurrence of the error condition for the (e.g., Java) extension code being executed, an application running in server 104 encodes an appropriate error message in a language-independent format (step 404). For example, the error message can be encoded in English in the NLS format. Later, as described in more detail below, when the error message reaches its ultimate destination (e.g., client layer), the message (e.g., in the NLS format) can be reconstituted in any particular language (e.g., Japanese) the client/user, system manager, or system programmer/architect desires. In any event, the flow proceeds to the next step in FIG. 4B.

Referring now to FIG. 4B (e.g., entitled “Encode NLS Error Message”), in order to encode the error message for this example, the application (e.g. Java application) in server 104 can perform an appropriate “Get” function for the error message involved. In response to the “Get”function, the application can return the (Java resource) bundle Name, message id, and message arguments (e.g., values or references to be passed to the client application by the message creator) for the error message involved. Next, the application encoding the error message (e.g., in server 104) can initialize the message string to be encoded with an initial “empty” string (step 418). The encoding application then appends the begin delimiter, bundleName, argument delimiter, message id, end delimiter, and the message arguments (e.g., in the NLS format) for the error message to the initialized message string (step 420). For example, the error message arguments can be formatted in the English language in accordance with the NLS principles (e.g., using AIX Version 4.3 programming concepts), and then the NLS-formatted error message can be stored in a message catalog in server 104.

Next, the encoding application in server 104 determines whether or not there are any additional message arguments to be encoded (step 422). If so, the encoding application appends any additional argument delimiter(s) and related message argument(s) to the error message string (step 424). Otherwise, if there are no additional message arguments to be encoded, the encoding application can append an end delimiter to the encoded message string (step 426). The encoding application then returns the encoded (e.g., NLS-formatted) message string for further processing (step 428).

Returning to FIG. 4A, the process application in server 104 determines whether or not there are any additional messages to encode (step 406). If so, the flow returns to step 404. Otherwise, if there are no additional messages to encode, the process application in server 104 conveys the encoded NLS (error) message to the intermediate management framework (e.g., the CIM management framework) for transport to the client layer (step 408).

Next, at the client layer, the client user interface receives the encoded message via the transport mechanism of the intermediate management framework involved (step 410). For this exemplary embodiment, it may be assumed that the user interface for the particular user involved is running on client 108. As such, for this example, the NLS error message can be decoded automatically by client 108 as part of a sub-step in a broader-scoped operation (step 412). For example, the NLS error message can be decoded by a substep of a common system management function such as “create a new resource”. The flow then proceeds to the next step in FIG. 4C.

Referring to FIG. 4C (e.g., entitled “Decode NLS Error Message”), for this exemplary embodiment, a decoding application (e.g., running in client 108) performs a “Get” function for the received message string to be decoded (step 430). The decoding application then determines which begin delimiter in the encoded string is the innermost begin delimiter in that string (step 432). The decoding application then decodes the bundle Name, message id, and message argument(s) associated with the innermost begin delimiter in the encoded message string (step 434). Next, the decoding application determines whether or not there are any additional begin delimiters and/or end delimiters remaining in the encoded message string (step 436). If so, the decoding application performs a “Get” function to get the next outermost delimiter pair (e.g., related begin-end delimiters) in the encoded message string (step 438). The flow then returns to step 434.

Otherwise, if (at step 436) the decoding application determines there are no additional begin delimiters and/or end delimiters in the message string being decoded, then the decoded message string (e.g., in NLS format) is returned to the client application for consumption by the user (step 440) via the user interface. The flow proceeds to step 414 in FIG. 4A. At this point, the client can reconstitute the decoded error message (e.g., in NLS form) to a language of interest (e.g., Japanese). In accordance with principles of the present invention, the above-described process can encode a message in a language-independent form, transport the message through a management framework, and decode and reconstitute the message in a desired language form.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for transporting a message through a management framework, the method comprising the steps of:
encoding at least one argument of said message in a language-independent form;
conveying said at least one argument of said message in a language-independent form through a management framework;
receiving said at least one argument of said message in a language-independent form at a layer above the management framework; and
decoding said at least one argument of said message in a language-independent form.

2. The method of claim 1, wherein said language-independent form comprises a National Language Support (NLS) form.

3. The method of claim 1, wherein said management framework comprises an intermediate management framework.

4. The method of claim 1, wherein said layer above the management framework comprises a client layer.

5. The method of claim 1, further comprising the step of reconstituting said decoded at least one argument in a specific language form.

6. The method of claim 1, wherein said management framework comprises a Common Information Model (CIM) management framework.

7. The method of claim 1, wherein said management framework comprises a Simple Network Management Protocol (SNMP) management framework.

8. A data processing system for transporting a message through a management framework, comprising:
a first processing unit; and
a second processing unit coupled to said first processing unit, said first processing unit operable to:
encode at least one argument of said message in a language-independent form; and
convey said at least one argument of said message in a language-independent form through a management framework, said second processing unit operable to:
receive said at least one argument of said message in a language-independent form at a layer above the management framework; and
decode said at least one argument of said message in a language-independent form.

9. The data processing system of claim 8, wherein said language-independent form comprises a National Language Support (NLS) form.

10. The data processing system of claim 8, wherein said management framework comprises an intermediate management framework.

11. The data processing system of claim 8, wherein said layer above the management framework comprises a client layer.

12. The data processing system of claim 8, wherein said second processing unit is further operable to:
reconstitute said decoded at least one argument in a specific language form.

13. The data processing system of claim 8, wherein said management framework comprises a Common Information Model (CIM) management framework.

14. The data processing system of claim 8, wherein said management framework comprises a Simple Network Management Protocol (SNMP) management framework.

15. A computer program product in a computer readable medium for transporting a message through a management
placing magnetic field homogeneity enhancing material selected from the group consisting of: silicon dioxide, magnesium oxide and aluminum oxide in a argument of said message in a language-independent form;
second instructions for conveying said at least one argument of said message in a language-independent form through a management framework;
third instructions for receiving said at least one argument of said message in a language-independent form at a layer above the management framework; and
fourth instructions for decoding said at least one argument of said message in a language-independent form.

16. The computer program product of claim 15, wherein said language-independent form comprises a National Language Support (NLS) form.

17. The computer program product of claim 15, wherein said management framework comprises an intermediate management framework.

18. The computer program product of claim 15, wherein said layer above the management framework comprises a client layer.

19. The computer program product of claim 15, further comprising:
fifth instructions for reconstituting said decoded at least one argument in a specific language form.
